(19) United States
(12) Patent Application Publication
(10) Pub. No.: US 2013/0216712 A1
(43) Pub. Date: Aug. 22, 2013

(54) METHOD FOR PRODUCING A NON-SLIP COATING

(71) Applicant: Oskar MERZ, Zeltweg (AT)

(72) Inventor: Oskar MERZ, Zeltweg (AT)

(21) Appl. No.: 13/399,414

(22) Filed: Feb. 17, 2012

(51) Int. Cl. B05D 5/00

(52) U.S. Cl. 427/265

(57) ABSTRACT

A method for producing a non-slip coating on a carrier which is in the form of a sheet or can be unwound off a roll and has a first and second surface, comprising the steps of applying a single-colored or multi-colored printing process on at least the first surface of the carrier, and subsequently applying a covering layer comprising varnish to at least the first surface of the carrier, wherein the varnish is applied in the form of a grid by a printing process on the first surface of the carrier for improving friction-related treatment characteristics of the carrier for subsequent cutting, stamping or folding steps, and wherein said grid is applied with a maximum layer thickness of 7 g/m² on the at least first surface.

### BACKGROUND OF THE INVENTION

1. Field of the Invention

The invention relates to a method for producing a non-slip coating on a carrier which is in the form of a sheet or can be unwound off a roll, according to the preamble of claim 1.

2. Description of the Related Art

Methods of this type are commonly used especially when strip-type or sheet-type materials are supplied to subsequent, automated sections of a plant in which further treatment takes place. An example of application would for instance be the production of a packaging material, for which purpose a carrier, for example a paper web, is first unwound off a supply roll and supplied to further treatment steps such as cutting or bonding processes, or else merely storing. For trouble-free treatment of the paper web, it is accordingly necessary for the paper web to have specific treatment characteristics, for example a surface composition which ensures easy handling in usually automated transportation and treatment processes. Therefore, the paper web is for example provided with a covering layer consisting of non-slip material in order to increase the friction value, which will be referred to hereinafter also as the coefficient of friction or as the slip angle, of the carrier. Various non-slip materials are known, for example varnishes which are applied in liquid or paste-like form to one surface or both surfaces of the carrier and must subsequently harden or dry before further treatment of the carrier can take place. In order to achieve optimum friction characteristics, the entire surface to be coated of the carrier is in this case provided according to the prior art with a covering layer.

Nevertheless, the non-slip materials used for the coating are expensive, so that the advantage of improved treatment characteristics is associated with higher costs. Also, varnishes which are applied over the entire area can often be bonded very poorly to planned bonding points, as it is difficult to join the adhesive to the covering layer. Attempts are therefore often made not to provide the carrier at the planned bonding points with a covering layer. However, it must be ensured in this case that the bonding, which is usually carried out in an automated manner, takes place precisely at these recessed surface regions of the carrier; this sometimes causes difficulties. That leads in turn to higher costs, a greater risk of complaints and a greater risk of spoilage. Furthermore, the transition in those regions where there is no application of varnishes to the regions where there is an application of varnishes poses an aesthetic problem because the transition is visible by the naked eye and will be perceived by the customer as an impairment to the quality. Finally, the drying time required after the application of the covering layer reduces the overall treatment speed. Measures for more rapid drying, such as for example an increase in drying temperature, again entail higher energy costs.

DE 203 02 310 U1 proposes facilitating the use of everyday items, such as for example writing or other underlays, placemats as underlays for covers on dining tables and the like, by preventing slipping of these articles on a substrate. That is achieved using a polypropylene adhesive material as a non-slip material which has a residual tack after hardening. The adhesive material is in this case applied as a surface pattern.

DE 202 06 101 U1 proposes an anti-slip means for applying or fastening to a fixed substrate, in which an anti-slip lining is laminated in transparent form onto a signal strip.

DE 202004017840 U1 describes a plastics material planar structure comprising a planar, flexible plastics material carrier and a plastics material coating applied to the plastics material carrier, the coating forming a structured surface.

DE 199 38 828 A1 describes a paper or plastic material bag with a non-slip coating consisting of a grid-type or planar coating comprising a plastics material having a comparatively high coefficient of friction. The coating can be applied to individual points or else in the form of a grid. The aim of the non-slip coating is to avoid the slippage of palletized stacks. JP 03241092 describes a method for producing a non-slip coating on corrugated board with the aid of a varnish layer. The aim of such a coating is again improved storability of the material.

U.S. Pat. No. 4,421,805 also relates primarily to improving the stackability of shipping sacks by preventing mutual slippage thereof with the aid of a layer based on a polyamide resin. This layer can be applied over the entire area or else in the form of a grid.

DE 203 11 507 U1 relates to planar, non-slip material in the form of mats or rolls, which material is used as an underlay for securing heavy goods to be transported. The coating is intended in this case not to be tacky; this is achieved in that an organic monomer or polymer forming slightly tacky films, in the form of a suspension or paste consisting of “expandable microcapsules” in a solution, suspension or emulsion of the monomer or polymer, is applied to the mats. The mats are first available in the form of endless rolls which, after the coating, are cut to size accordingly. The coating takes place preferably over part of the area, for example in the form of strips.

EP 1 407 831 A2 is concerned with the production of sealing varnish layers on sheets or sheet composites, for example with the aid of gravure printing methods. The sheets can also be made of paper and serve for example to produce a flexible packaging material. Also described are plants for a packaging material of this type using an unwinding device, a laminating station, a printing station, a print overlay coating station, a sealing coating station and a winding station following said sealing coating station. EP 1 407 831 A2 proposes in this case, with regard to the sealing coating station, a method for producing a sealing layer covering part of the area with the aid of electrostatic coating methods.

All known methods for improving the frictional properties further come with the further disadvantage that precise setting of the coefficient of friction is hardly possible. One reason is that the uncoilable or curved carrier varies in its properties, especially concerning its smoothness. These variations are hardly recognizable, but result in different coefficients of friction in the application of the varnish. The surface of the carrier is not perfectly flat in a strongly enlarged view, but shows a complex topography with a large number of elevations and depressions which lead to a different absorbing capacity of the carrier. An application of varnish which is constant in respect of quantity results in varying coefficients of friction in the case of a varying topography of the carrier. One possibility for avoiding this problem is the choice of a sufficient layer thickness of the varnish, which on the other hand leads to higher production costs.

Furthermore, the improved frictional properties for the following processing steps are often only necessary in a few areas of the carrier. As a result, a high friction angle is necessary at support points of drawing rollers for the following processing steps, whereas the remaining area of the pressure carrier should be provided with favorable slipping properties.

### SUMMARY OF THE INVENTION

It is therefore the aim of the invention to provide methods which avoid these drawbacks. Furthermore, it would be desirable, if the friction value of the strip-type or sheet-type material could be optimized for the respective subsequent treatment process; at present, this would be conceivable only by using different non-slip materials, or by using a non-slip material having for example varying viscosity. These aims are achieved by the features of claim 1.

It is a further object of the invention to allow the precisest possible setting of the angle of friction even in the case of varying topography of the carrier, which angle of friction can also be chosen differently over the area of the carrier without causing any optical disadvantages to the carrier.

Claim 1 relates to a method for producing a non-slip coating on a carrier which is in the form of a sheet or can be unwound off a roll and has a first and second surface, comprising the steps of applying a single-colored or multi-colored printing process on at least the first surface of the carrier, and subsequently applying a covering layer comprising varnish to at least the first surface of the carrier, wherein the varnish is applied in the form of a grid by a printing process on the first surface of the carrier for improving friction-related treatment characteristics of the carrier for subsequent cutting, stamping or folding steps, and wherein said grid is applied with a maximum layer thickness of 7 g/m² on the at least first surface. According to the invention, thus, provision is in this case made for the covering layer is applied by a printing process in the form of a grid. The reason for this is that it has surprisingly been found that the slip angle of a material is significantly higher, compared to coating with the covering layer over the entire area, if the surface is not coated all over. Thus, not only can the slip angle be increased, as is often broadly desirable, for example in the packaging industry, but rather expensive material for producing the covering layer can at the same time be saved.

Specifically, observations made by the Applicant reveal that the slip angle first increases, starting from coating of the carrier over the entire area, if the coverage ratio, i.e. the ratio between the partial areas covered by the covering layer and the total area of the respective surface of the carrier, is reduced, starting from a value of 100%, to lower percentages. Further reduction of the coverage ratio ultimately leads to passing-through of a maximum value of the slip angle which is greater than the slip angle in the case of coating over the entire area. After passing through this maximum value, the anticipated behavior is finally established in that the slip angle decreases, the smaller the partial areas of the surface of the carrier which are provided with the covering layer are selected to be. At a specific coverage ratio, ultimately the same slip angle is established as when the surface is completely covered. However, this situation itself leads to a considerable saving in non-slip material for the covering layer. If the coverage ratio is further reduced, the slip angle eventually drops below this value and subsequently decreases more and more until it assumes that value which corresponds to the slip angle of the uncoated carrier.

By providing the application of the varnish by means of a printing process, a precise application of varnish can occur as a result of a suitable choice of the grid and the layer thickness. In order to ensure that the precise application of varnish always provides the carrier with the same coefficient of friction, it is further provided in accordance with the invention that prior to the application of the varnish a printing process occurs in the regions in which subsequently the application of varnish is performed. As a result of the application of the color in the course of the printing process, the aforementioned elevations and depressions in the carrier surface will be leveled to the highest possible extent, so that the subsequent application of varnish leads to predictable and repeatable coefficients of friction of the carrier. As a result, the quantity of varnish can usually be reduced by more than 50% with the help of the preceding printing process while maintaining constant frictional properties of the carrier, and the production costs can therefore be reduced. If layers of varnish are conventionally applied with layer thicknesses of more than 20 g/m² all over the surface area, a reduction in the layer thickness of the application of the varnish of less than 10 g/m² is achieved by means of the method in accordance with the invention while maintaining constant frictional values. Notice must be taken that in printing technology layer thicknesses are usually not stated in micrometers but as mass per area, e.g. in the unit of grams per square meter. In the case of conventional varnishes however an all-over application of a mass of one gram per square meter corresponds approximately to a layer thickness of one micrometer.

In order to further prevent the aforementioned quality impairments by an abrupt transition between varnished and non-varnished regions, it is further proposed in accordance with the invention that the layer thickness of the varnish grid is at most 7 g/m², preferably at most 3 g/m². It has been noticed that such an upper limit hardly causes any optical impairments to the carrier, even if the varnish grid is varied over the surface of the carrier since the variations can hardly be perceived by the viewer beneath the upper limit in accordance with the invention. It has further been seen that in the case of exceeding this upper limit of 7 g/m² disadvantageous effects concerning the precise setting of the angle of friction will become noticeable in the case of a grid-type application of varnish.

In accordance with a preferred embodiment, it is proposed for the further improvement of the visual properties of the carrier that the varnish grid is continuously varied over the surface of the carrier. A continuous progression can easily be realized as a result of the grid-type application of varnish in accordance with the invention. It is possible to vary either the coverage ratio by different choice of the grid or the layer thickness of the applied grid.

For the covering layer to be applied in the form of a grid, a person skilled in the art has at his disposal a plurality of printing methods with which he is very familiar and which allow the non-slip material to be applied to the surface of the carrier in the form of a grid. Varying the grid allows the above-mentioned coverage ratios to be ensured, as will be described in greater detail below. The coverage ratio will also be referred to hereinafter in conjunction with a grid as the “percentage of the grid”.

In particular, a preferred embodiment utilizes the observation that varying the coverage ratio allows the slip angle of the material to be purposefully altered. Thus, according to a preferred embodiment, the ratio between the areas covered by said grid and the total area of the first surface of the carrier is chosen to vary along the area of the first surface as a function of desired varying friction values of the first surface. This allows the friction value of the strip-type or sheet-type material to be precisely adapted to the respective subsequent treatment process.

Another preferred embodiment provides for the layer thickness of the covering layer to be selected as a function of the desired friction value of the surface. Should, for example, the impression of a closed covering layer be necessary for the purposes of gloss, the coverage ratio can be selected so as to be higher while at the same time reducing the layer thickness. It is thus possible to obtain the visual impression of a closed covering layer, but nevertheless achieve a considerable saving owing to the reduced layer thickness.

### BRIEF DESCRIPTION OF THE DRAWINGS

The invention will be described hereinafter in greater detail with reference to the appended drawings, in which:

FIG. 1 is a schematic cross section along the line A-A from FIG. 4 of a portion of a material according to the invention consisting of a carrier, a printed layer and a covering layer;

FIG. 2 is a schematic view of the material from FIG. 1, viewed from above, for a first coverage ratio;

FIG. 3 is a schematic view of the material from FIG. 1, viewed from above, for a second coverage ratio; and

FIG. 4 is a schematic view of the material from FIG. 1, viewed from above, for a third coverage ratio.

### DETAILED DESCRIPTION OF THE PREFERRED EMBODIMENTS

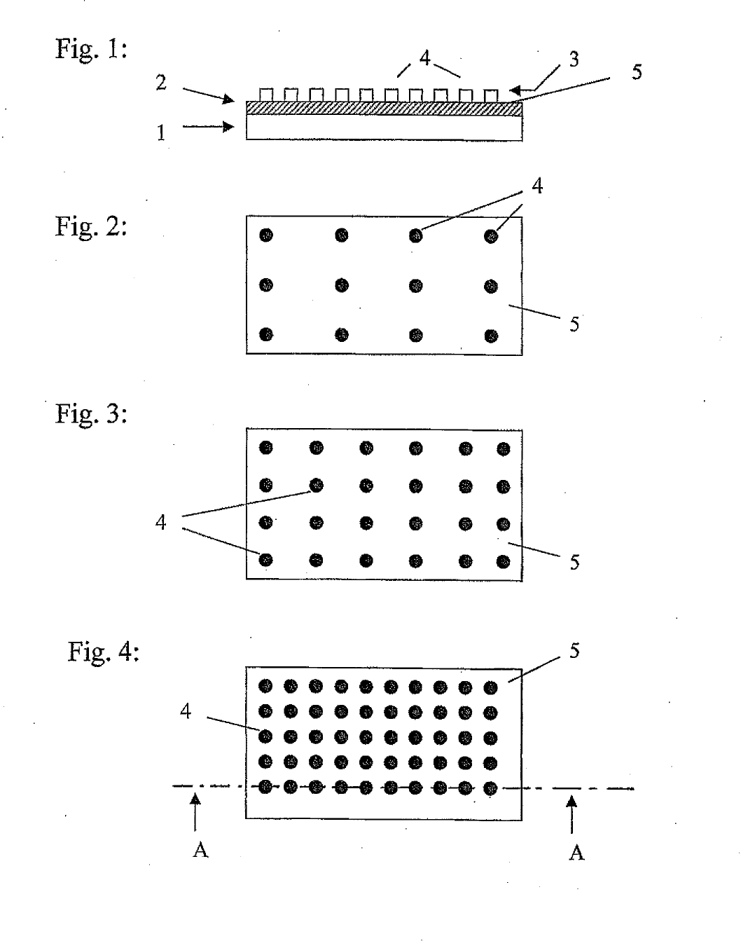

FIG. 1 is a schematic view of a material according to the invention consisting of a carrier 1, optionally a printed layer 2, and a covering layer 3. The carrier 1 can for example be a paper web, a sheet of paper, a cardboard, a textile, an aluminum foil, a plastics material film, a composite sheet made of at least two of the aforementioned materials or the like. In any case, the carrier 1 can be unwound off a roll or in the form of a sheet, and is not suitable to be supplied to subsequent treatment steps during the course of automated treatment processes.

The printed layer 2 can also consist of a plurality of colored layers, for example if a plurality of colored planes is applied during the course of the imprinting of the carrier 1.

As mentioned hereinbefore, it is necessary for trouble-free treatment of the carrier 1 in subsequent treatment steps for the carrier 1 to have specific treatment characteristics, for example a surface composition which ensures easy handling in usually automated transportation and treatment processes. Therefore, the carrier 1 is provided with a covering layer 3 consisting of non-slip material in order to increase the friction value of the carrier 1. FIG. 1 shows for example that only the upwardly oriented surface of the carrier 1 or the printed layer 2 is provided with a covering layer 3, but not the downwardly oriented surface of the carrier 1. However, it is also possible for both surfaces of the carrier 1 to be provided with a printed layer 2 and/or a covering layer 3.

Various non-slip materials are known, for example varnishes which are applied in liquid or paste-like form to one or both surfaces of the carrier 1 and subsequently must harden or dry before further treatment of the carrier 1 can take place. These varnishes are colorless, gloss or matt drying materials which are applied to the carrier 1 or the printed layer 2 either as a printing varnish by the printing machine or as a water-based dispersion varnish by an independent printing varnishing unit. Within the printing process, the varnishing is usually the last printing phase and not only improves the appearance of a printed product, but rather also increases, especially in the case of matt paper, the abrasion resistance of the printed colors of the printed layer 2. However, last but not least, these varnishes also have a non-slip effect which is utilized in the case of a subsequent treatment of the printed product. In the conventional manner, the entire surface to be coated of the carrier 1 is in this case provided with a covering layer 3 in order to achieve optimum friction characteristics. The covering layer 3 also has the purpose of protecting the printed layer 2 lying therebelow from color abrasion.

However, according to the invention, provision is made for the covering layer 3 to be applied only over partial areas of the surface of the carrier 1. As mentioned hereinbefore, the slip angle of a material is significantly higher, compared to coating with the covering layer 3 over the entire area, if the surface is not coated all over. In a preferred manner, the covering layer 3 is applied for example in the form of a grid, the shape of the grid being in principle immaterial. Depending on the case of application, different grid shapes can prove to be suitable, the selection of the optimum grid shape being a conventional task for a person skilled in the art. Different coverage ratios can be ensured by varying the grid. FIGS. 2 to 4 show for instance a simple example of a grid consisting of individual grid points 4 arranged in a uniform arrangement over the surface 5 of the carrier 1 or the printed layer 2. A grid point 4 is in this case a printable image element which can be applied at various distances from one another or in various sizes. The grid shown by way of example in FIGS. 2 to 4 would correspond for instance to a frequency-modulated grid, i.e. a grid in which the surface 5 is divided into grid points 4 of the same size, the percentage of the grid, i.e. of the coverage ratio, being varied over the number of points in the area (the frequency). The grid points 4 could in this case also be arranged stochastically. In contrast thereto, the surface 5 could however also be divided into a fixed number of grid points 4 (for example a “24 grid”: 24×24 points per cm²), and the percentage of the grid could be varied over the size of the points (the amplitude), this case also being known as an amplitude-modulated grid. These two types of grid can however also be combined. FIGS. 2 to 4 illustrate schematically a grid shape having in each case differing percentages. FIG. 2 shows for example a grid having a comparatively low coverage ratio. If, for example, 30% of the total area of the surface 5 is covered with grid points 4, the grid is also said to be a “30% grid”. In FIG. 3, the number of grid points 4 has been increased and represents for example a “50% grid”. Finally, FIG. 4 illustrates schematically a “70% grid”. All other types of grid shapes and coverage ratios are however also conceivable.

For applying the grid point 4, a person skilled in the art has at his disposal a plurality of well-known printing methods with which the non-slip material can be applied to the surface 5 of the carrier 1 in the form of a grid. The selection of the optimum printing method will depend on the characteristics of the carrier 1 or the printed layer 2, on the requirements owing to the subsequent treatment steps, on the nature of the non-slip material, or else simply on the question of cost. Depending on the case of application, a person skilled in the art will thus opt for different relief, planographic, gravure or through-printing methods, such as for example flexographic printing, offset printing, screen printing, or else thermal printing methods. The substantive invention can in any case be carried out using all these printing methods.

If the starting point taken is a carrier 1 made of a specific material, for example a sheet of paper, then this carrier 1 has, after imprinting with the printed layer 2, a specific friction value (slip angle). This slip angle is smaller than that slip angle which is obtained in the event of varnishing with the covering layer 3 over the entire surface. Varnishing with the covering layer 3 over the entire surface in the form of a grid is what is known as a “100% grid”. As mentioned hereinbefore, the slip angle first increases, starting from such coating of the carrier 1 or the printed layer 2 over the entire surface, when the percentage of the grid is reduced, for example to a 70% grid (FIG. 4). In the event of further reduction of the coverage ratio, there is finally passed through, for example in the case of a 50% grid (FIG. 3), a maximum value of the slip angle which is greater than the slip angle in the event of coating over the entire area. Once this maximum value has been passed through, the anticipated behavior is finally established in that the slip angle decreases, the smaller the partial areas of the surface 5 of the carrier 1 which are provided with the covering layer 3 are selected to be. At a specific coverage ratio, the same slip angle is ultimately established as when the surface is completely covered. In a 24 grid, that would for example be the case in a 30% grid (illustrated in FIG. 2). However, this situation already leads to a considerable saving in non-slip material for the covering layer 3 of approximately 70%. In the event of further reduction of the coverage ratio, the slip angle finally falls below this value and subsequently decreases more and more until it assumes that value corresponding to the slip angle of the uncoated carrier 1 or the printed layer 2.

Varying the coverage ratio therefore allows the slip angle of the varnished printing unit to be purposefully altered. The ratio between the partial areas covered by the covering layer 3 and the total area of the respective surface 5 of the carrier 1 must merely be selected as a function of the desired friction value (slip angle) of the surface 5. This allows the friction value of the strip-type or sheet-type material according to the invention to be adapted to the respective subsequent treatment process.

In order to ensure that the precise application of varnish will always provide carrier 1 with the same coefficient of friction, it is further provided in accordance with the invention that there is a printing process prior to the application of varnish at least in those areas in which subsequently the application of varnish will be performed. As already described above, different absorptive capacities of the carrier surface are compensated substantially by the application of the color in the course of the printing process, so that the subsequent application of varnish will result in predictable and repeatable coefficients of friction of the carrier 1. As a result, the quantity of varnish can be reduced additionally by means of the preceding printing process in combination with constant frictional properties of the carrier 1, and the production costs can thereby be reduced.

The application of the varnish further protects the underlying color layer 2 from abrasion of the color. This protection is also not reduced by the use of a grid instead of an application over the entire surface area. Moreover, the application of the varnish provides the color layer 2 with additional gloss depending on the type of the carrier 1.

The grid of the varnish is preferably varied in a continuous manner over the surface of the carrier in order to prevent abrupt transitions between varnished and non-varnished areas. A continuous progression can easily be realized as a result of the grid-type application of varnish in accordance with the invention by way of a printing process, with either the coverage ratio being varied by different choice of the grid or the layer thickness of the applied grid.

With the method according to the invention or the material according to the invention, it is thus possible to reduce the amount of non-slip material used for the coating; this is associated with a significant reduction in cost. Furthermore, bonding processes can be carried out more easily as, owing to the grid, the adhesive, for example glue, can establish a connection to the carrier 1, for example paper, and thus obtain the necessary bonding characteristics. That leads in turn to lower costs, and also to a lesser risk of complaints and spoilage. Finally, owing to the smaller amounts of the material necessary for the covering layer 3, the required drying time can be reduced, and this increases the overall treatment speed. Measures for more rapid drying, such as for example an increase in the drying temperature or the like, are no longer necessary or are necessary to a reduced extent.

What is claimed is:

1. A method for producing a non-slip coating on a carrier which is in the form of a sheet or can be unwound off a roll and has a first and second surface, comprising the steps of applying a single-colored or multi-colored printing process on at least the first surface of the carrier, and subsequently applying a covering layer comprising varnish to at least the first surface of the carrier,
wherein the varnish is applied in the form of a grid by a printing process on the first surface of the carrier for improving friction-related treatment characteristics of the carrier for subsequent cutting, stamping or folding steps, and wherein said grid is applied with a maximum layer thickness of 7 g/m² on the at least first surface.

2. The method according to claim 1, wherein said grid is applied with a maximum layer thickness of 3 g/m² on the at least first surface.

3. The method according to claim 1, wherein said grid is chosen to vary along the area of the first surface in a continuous manner.

4. The method according to claim 3, wherein the layer thickness of said grid is chosen to vary along the area of the first surface as a function of desired varying friction values of the first surface.

5. The method according to claim 3, wherein the ratio between the areas covered by said grid and the total area of the first surface of the carrier is chosen to vary along the area of the first surface as a function of desired varying friction values of the first surface.
